(19) United States
(12) Patent Application Publication
(10) Pub. No.: US 2002/0075130 A1
(43) Pub. Date: Jun. 20, 2002

(54) Resistor excellent in micro-linearity characteristic and variable resistor using the same

(75) Inventors: Yoshihiro Taguchi, Miyagi-ken (JP); Hisashi Komatsu, Miyagi-ken (JP); Takayuki Fujita, Miyagi-ken (JP); Michita Suzuki, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD

(21) Appl. No.: 10/001,130

(22) Filed: Oct. 30, 2001

(30) Foreign Application Priority Data
Oct. 31, 2000 (JP) 2000-337261

(51) Int. Cl. H01C 10/30

(52) U.S. Cl. 338/160

(57) ABSTRACT

The invention provides a resistor excellent in micro-linearity and further, the durability to sliding as well as a high-precision variable resistor using the resistor and having a long life. A lower layer and an upper layer of the resistor are laminated, the surface of a resistor on which a slider is slid is formed of the upper layer and resistivity of the upper layer is smaller than that of the lower layer.

### BACKGROUND OF THE INVENTION

1. Field of the Invention

The present invention relates to a resistor excellent in micro-linearity characteristic and a high-precision variable resistor using the same.

2. Description of the Related Art

A conventional type resistor which has been used for variable resistors of various sensors has at least two layers of a lower layer and an upper layer, and the surface of the upper layer functions as a face on which a slider is slid. The upper layer and the lower layer respectively contain conductive particles such as carbon black in binder resin and the upper layer has larger resistivity than the lower layer. Such a resistor is designed on the premise that the upper layer is shaved by the slider and it has been considered that the shaving of the resistor has no influence upon the electric characteristic of the resistor in the life of a product.

A resistor used for a high-precision sensor is required to have an excellent micro-linearity characteristic. A graph shown in FIG. 4 shows the findings of an influence which the amount of carbon black (CB), the amount of carbon fiber (CF) respectively contained in the upper layer (the layer touched to the slider) and the central particle size of the carbon fiber (CF) have upon the micro-linearity characteristic in a quality experiment.

The graph shows that the factor of which the change of the signal-to-noise ratio is larger has a larger influence upon micro-linearity. It is known from the graph shown in FIG. 4 that the factor which has the largest influence upon micro-linearity is the amount of carbon black contained in the upper layer.

FIG. 5 is a graph showing the relation between the resistivity of the upper layer which is the face where the slider is slid and the micro-linearity characteristic when the central particle size range of the carbon fiber contained in the upper layer is 1.4 μm or 8.7 μm. As described later, the smaller variation is, the better the micro-linearity characteristic is. It is known from a graph shown in FIG. 3 that the smaller the resistivity of the upper layer is, the more the micro-linearity characteristic is enhanced in both cases in the central particle size of the contained carbon fiber.

As in the conventional type resistor, the resistivity of the upper layer which is the face where the slider is slid when the conventional type resistor is composed of two or more layers is set to a higher value than that of the lower layer, the conventional type resistor has a problem that a particularly excellent micro-linearity characteristic cannot be expected and it is difficult to use a variable resistor using such a resistor for a high-precision sensor. The conventional type resistor also has a problem that as the upper layer contains no carbon fiber, sufficient durability to sliding is not acquired.

### SUMMARY OF THE INVENTION

The object of the invention is to provide a resistor excellent in micro-linearity characteristic and further, durability to sliding as well as a high-precision variable resistor using the resistor and having a long life.

Next, the micro-linearity characteristic will be described. In a graph shown in FIG. 6, when rated voltage Vin is applied in a longitudinal L-direction of a resistor pattern, the y-axis shows output V from a slider slid in the direction of the length on the resistor pattern and the x-axis shows the position X of the slider on the resistor pattern. On the premise that the specific resistance of the resistor is fixed independent of the position, the change of output when the slider is moved from an arbitrary point by ΔX on the resistor pattern can be shown by an ideal straight line P having the inclination of (ΔX/L)×Vin.

For the ideal straight line P, reference output displacement when the slider is moved from a point A to a point B by ΔX can be expressed by ΔV (ΔX/L)×Vin, however, actual output S is off the ideal straight line P. As shown in the following expression 1, the variation of the actual output S from the ideal straight line P is defined as a difference between the output displacement VB−VA of each actual output Va and VB at the points A and B and reference output displacement shown by the percentage of applied voltage, and the smaller the variation is, the better the micro-linearity characteristic is. A particularly excellent micro-linearity characteristic that actual output S is close to the ideal straight line P is required for a high-performance positional sensor.

$$Variation = \frac{( {V}_{B} - {V}_{A} ) - [ \frac{Δ X}{L} ] {V}_{in}}{{V}_{in}} \times 100 \qquad [ Equation 1 ]$$

V_{A}: Output value when slider is positioned at point A

V_{B}: Output value when slider is positioned at point B

Vᵢₙ: Applied voltage in longitudinal L-direction of resistor

ΔX: Distance between point A and point B

L: Resistor length

For the resistor according to the invention, first and second resistors contain conductive particles in binder resin, the second resistor contains carbon fiber and carbon black, the central particle size range of the carbon fiber contained in the second resistor is 3.5 to 9.0 μm, resistivity of the second resistor is smaller than that of the first resistor, at least the first and second resistors are laminated, the second resistor covers an upside of the first resistor and a surface is formed of the second resistor.

In such a resistor, the conductive particles serve to apply conductivity to the first and second resistors. If binder resin has only to serve to uniformly disperse the conductive particles and to bind these, the material is not limited and for example, thermosetting resin such as phenol-formaldehyde resin, xylene denatured phenol resin, epoxy resin, polyimide resin, melamine resin, acrylic resin, acrylate resin, furfuryl resin and polyimide resin and others can be used.

The carbon black contained in the second resistor is conductive particles for applying conductivity to the second resistor, and acetylene black, furnace black, channel black and others can be used. The resistivity of the second resistor can be regulated by the percentage content of the carbon black.

The carbon fiber contained in the second resistor is conductive particles and serves to apply conductivity to the second resistor, to disperse and support a load applied to the resistor by the slider in a direction of fiber length and to enhance the durability to the sliding of the slider of the resistor. Therefore, the resistor is not shaved by the slider and no variation of the electric characteristic by the shaving of the resistor occurs.

Further, as the carbon fiber which is conductive particles supports the load of the slider in the resistor according to the invention, electric contact between the resistor and the slider is stabilized. If the central particle size of the carbon fiber is smaller than 3.5 μm, the load cannot be supported.

Generally, as carbon fiber has anisotropy in conduction that a current is liable to flow in the direction of fiber length, an influence of the anisotropy in conduction of the carbon fiber becomes remarkable when the central particle size of the carbon fiber exceeds 9.0 μm and the micro-linearity characteristic of the resistor is deteriorated.

Such a resistor can have a desired value by reducing the resistivity of the second resistor on which the slider is slid, reducing contact resistance between the slider and the resistor, enhancing the micro-linearity characteristic of the resistor and regulating the resistance value of the whole resistor by the resistivity of the first resistor because the resistor is provided with at least the first and second resistors.

In the resistor according to the invention, the first resistor contains carbon fiber and carbon black.

In such a resistor, the carbon black contained in the first resistor is a conductive particle that applies conductivity to the first resistor and the resistivity of the first resistor can be regulated by the percentage content of the carbon black. For the carbon black, acetylene black, furnace black, channel black and others can be used.

The carbon fiber contained in the first resistor is a conductive particle that applies conductivity to the first resistor and serves to enhance the hardness of the first resistor, to support the second resistor and to prevent the second resistor from sinking when the second resistor is pressed by the slider.

In the resistor according to the invention, a central particle size of the carbon fiber contained in the first resistor is equal to or smaller than that of the carbon fiber contained in the second resistor.

In such a resistor, as the central particle size of the carbon fiber contained in the first resistor is small, an influence by the carbon fiber contained in the first resistor upon the micro-linearity characteristic is small.

In the resistor according to the invention, the second resistor contains carbon fiber by 16 to 20% by volume.

In such a resistor, as the carbon fiber is contained in the second resistor by 16% by volume or more, enough points which support the load of the slider exist and the durability to sliding is enhanced. When the percentage content of the carbon fiber in the second resistor is 20% by volume or less, the amount of binder resin to the carbon fiber is enough and the carbon fiber is completely bound by the binder resin. Therefore, a pattern can be accurately formed in a screen printing process without the carbon fiber getting out of the resistor, the surface of the resistor is smoothed and the durability to sliding can be held.

Further, when the percentage content of the carbon fiber in the second resistor is 20% by volume or less, it is suitable for patterning in the screen printing process.

In the resistor according to the invention, a ratio of the resistivity of the second resistor to the resistivity of the first resistor is equal to or larger than 0.1 and is smaller than 1.

In such a resistor, when the resistivity of the second resistor is smaller than that of the first resistor, contact resistance between the resistor and the slider decreases and the micro-linearity characteristic is enhanced, while the anisotropy in conduction of the carbon fiber contained in the second resistor has an influence upon the micro-linearity characteristic. Therefore, an optimum micro-linearity characteristic can be acquired by setting the resistivity of the second resistor in a suitable range for the resistivity of the first resistor.

In the resistor according to the invention, a surface of the second resistor is smoothed and maximum surface roughness is set to 0.5 μm or less.

In such a resistor, as the surface on which the slider is slid of the resistor is smooth and the slider is smoothly slid, impact upon the slider is inhibited, an output signal from the slider can be prevented from being disturbed by the impact and the durability to sliding is also enhanced.

The variable resistor according to the invention uses the abovementioned resistor and a slider made of metal is slid on the surface of the second resistor.

In such a variable resistor, as the durability of the surface of the resistor on which the slider is slid to sliding is excellent, the variable resistor has a long life and as the micro-linearity characteristic of the resistor is satisfactory, it can be used for a high-precision sensor.

### BRIEF DESCRIPTION OF THE DRAWINGS

FIG. 1 is an explanatory drawing showing a variable resistor according to the invention;

FIG. 2 is a sectional view viewed along a line 2-2 in FIG. 1;

FIG. 3 is a graph showing an influence of the resistivity of an upper layer to that of a lower layer upon a micro-linearity characteristic;

FIG. 4 shows the factorial effect of micro-linearity;

FIG. 5 is a graph showing an influence of the resistivity of the upper layer upon the micro-linearity characteristic; and

FIG. 6 is an explanatory drawing showing the micro-linearity characteristic.

### DETAILED DESCRIPTION OF THE PREFERRED EMBODIMENTS

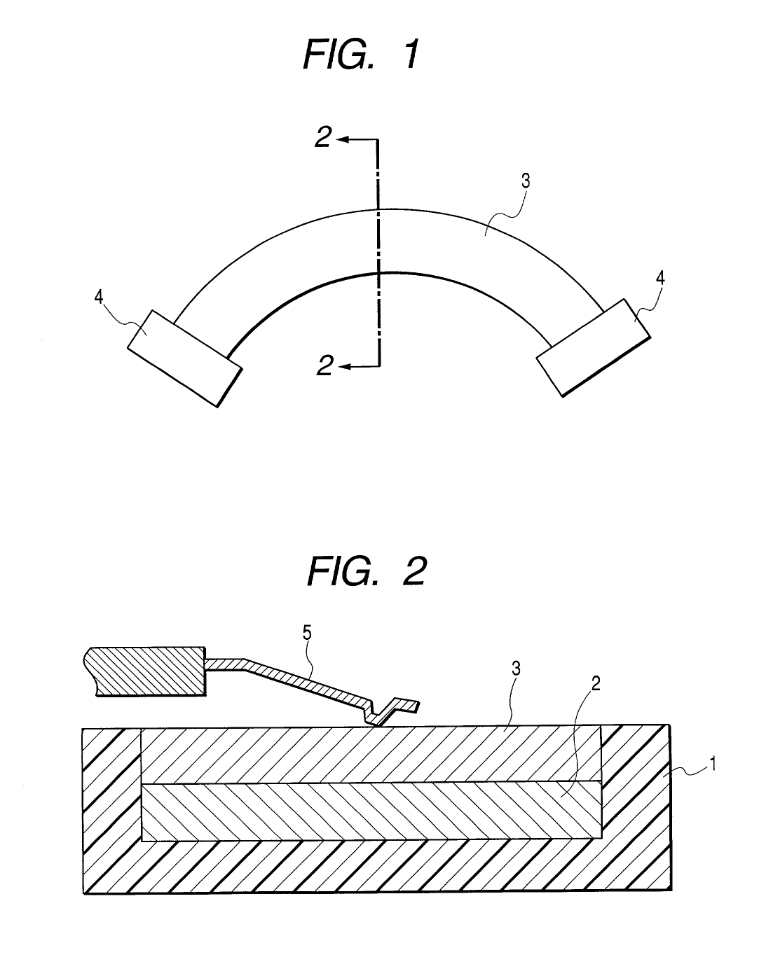

An embodiment of a resistor according to the invention will be described below. The embodiment of the resistor according to the invention has a two-layer structure in which a lower layer 2 which is a first resistor and an upper layer 3 which is a second resistor are sequentially laminated in a concave portion of base material 1 as shown in FIG. 2 and is set to a predetermined resistance value as a whole.

The lower layer 2 contains carbon black (acetylene black) or carbon black and carbon fiber in acetylene terminal polyimide resin which functions as binder.

The carbon black and the carbon fiber serve to apply conductivity to the lower layer 2 as conductive particles and particularly, the resistivity of the lower layer 2 can be regulated by the percentage content of carbon black.

Acetylene terminal polyimide resin which functions as binder serves to uniformly disperse carbon black and carbon fiber in the lower layer 2 and bind these.

The percentage content of carbon black in the lower layer 2 is 10 to 15% by volume. When the lower layer 2 contains carbon fiber, the percentage content of the carbon fiber (hereinafter called first carbon fiber) contained in the lower layer 2 is 10 to 16% by volume and the central particle size range of the first carbon fiber is 1.4 to 3.4 μm.

The central particle size of the carbon fiber means the central particle size of distribution when normal distribution can be applied to the particle size distribution of the carbon fiber.

The first carbon fiber is acquired by grinding commercial carbon fiber (for example, Torayca MLD product of Toray, and Besfight HTA-CMF product of Toho Rayon) of which the fiber size is approximately 8 μm and of which the fiber length ranges from 10 μm to approximately 100 μm (central particle size: 20 μm).

To grind commercial carbon fiber, a jet mill grinding method is used and for a grinding condition, commercial carbon fiber is thrown at the rate of 1 to 3 g per minute, making the compressed air of 6 to 7 kg/cm² flow into a cyclone having the size of 150 mm at the rate of 0.2 to 0.6 m³ per minute.

It is desirable that a coupling process is applied to the first carbon fiber. To describe the coupling process of the first carbon fiber in detail, after carbon fiber on the market is ground, it is mixed with water and ethanol by a coupling agent such as aminosilanate and after it is stirred for approximately two hours, it is filtered and is dried at approximately 100° C.

For the coupling agent, a silanate, titanate or alumina coupling agent can be also used. The dispersibility and adhesiveness of the first carbon fiber in/to binder resin are enhanced by such a coupling process.

The upper layer 3 contains carbon black (acetylene black) of 15 to 20% by volume and carbon fiber of 10 to 20% by volume in acetylene terminal polyimide resin which functions as binder. The surface of the upper layer 3 is at the substantially same level as the surface of the base material 1 and the maximum surface roughness is 0.5 μm or less.

The carbon black and the carbon fiber serve to apply conductivity to the upper layer 3 as a conductive particle and particularly, the resistivity of the upper layer 3 can be adjusted according to the percentage content of carbon black.

The central particle size range of carbon fiber contained in the upper layer 3 (hereinafter called second carbon fiber) is 7.2 to 9.0 μm and is acquired by grinding carbon fiber on the market and applying a coupling process to it like the first carbon fiber.

Acetylene terminal polyimide resin which functions as binder resin serves to uniformly disperse carbon black and carbon fiber in the upper layer 3 and to bind these.

Next, a method of manufacturing the resistor according to the invention will be described. First, the upper layer 3 will be described. Resistant paste for the upper layer is acquired by adding acetylene black, the second carbon fiber and a printable modifier if necessary in a solvent in which acetylene terminal polyimide resin is dissolved, mixing and dispersing them using three roll mills. The solvent has only to be something to dissolve acetylene terminal polyimide resin and one or more types of glycol, ester, ether and others may be used.

Next, the resistant paste for the upper layer is patterned on the smooth surface of a metallic plate by screen printing. At this time, as the percentage content of the second carbon fiber in the upper layer 3 is 20% by volume or less, the second carbon fiber is prevented from getting out of binder resin and projecting out of a pattern.

Next, the upper layer 3 is completed by applying a heating process at 200° C. for thirty minutes, drying and hardening the resistant paste for the upper layer. At this time, as the solvent is volatilized by the heating process, the upper layer 3 contains no solvent component.

The lower layer 2 is laminated on the upper layer 3 and is formed as the upper layer 3. The upper layer 3 and the lower layer 2 are transferred from the metallic plate and the base material 1. At this time, the surface of the upper layer 3 is smooth because the surface of the metallic plate is smooth, and the maximum surface roughness is inhibited so that it is 0.5 μm or less. As the percentage content of the second carbon fiber in the upper layer 3 is 20% by volume or less, the second carbon fiber is prevented from getting out of binder resin and projecting from the surface of the upper layer 3.

A variable resistor according to the invention uses the abovementioned resistor, when the resistor is used for a rotary variable resistor, it is formed in the shape of a resistor pattern P in the shape of an arc shown in FIG. 1 and when the resistor is used for a slide type variable resistor, it is elongated.

A silver electrode 4 is connected to both ends of such a resistor pattern P and a slider 5 made of noble metal is mounted so that it is slid on the upper layer 3 and is moved along the resistor pattern P.

For the slider 5, noble metal which also keeps satisfactory contact with the resistor in sliding for a long term is used and concretely, something acquired by applying gold plating and silver plating to the surface of nickel silver and an alloy mainly made of palladium, silver, platinum or gold can be used.

When such a variable resistor is driven, constant voltage is applied from the silver electrode 4 to the resistor pattern P and the position of the slider 5 on the resistor pattern P is detected in the reference position of the resistor pattern P based upon an output voltage signal between a fixed contact (not shown) electrically connected to the resistor pattern P and the slider moved on the resistor pattern P.

At this time, as the second carbon fiber contained in the upper layer 3 serves to support a load applied to the resistor by the slider, the durability to the sliding of the slider 5 of the resistor is enhanced.

Further, as the second carbon fiber which is a conductive particle supports the load of the slider 5, electric contact between the resistor and the slider 5 is stabilized.

The first carbon fiber contained in the lower layer 2 enhances the hardness of the lower layer 2, supports the upper layer 3 and prevents the upper layer 3 from sinking by the pressure of the slider 5.

As the surface of the upper layer 3 on which the slider 5 is slid is smooth, the slider 5 is smoothly moved on the resistor. Therefore, impact upon the slider 5 is inhibited and an output voltage signal from the slider 5 is prevented from being disturbed by the impact.

When the resistivity of the upper layer 3 is small, contact resistance between the slider 5 and the resistor decreases and the micro-linearity characteristic of the resistor is enhanced. Each resistivity of the upper layer 3 and the lower layer 2 can be regulated by the percentage content of carbon black respectively contained in them. When the resistivity of the upper layer 3 is reduced, the resistance value of the whole resistor composed of the upper layer 3 and the lower layer 2 can be set to a desired value by regulating the resistivity of the lower layer 2.

The micro-linearity characteristic of the resistor is influenced by the central particle size of the carbon fiber respectively contained in the upper layer 3 and the lower layer 2. As the carbon fiber has anisotropy in conduction that a current is liable to flow in the direction of fiber length, the resistivity minutely varies for every current path depending upon the degree of the orientation in the direction of the fiber length of the carbon fiber in the current path when the upper layer 3 or the lower layer 2 contains the carbon fiber of which the central particle size is large, and the micro-linearity characteristic is deteriorated.

Embodiments in which the percentage content of the carbon black and the carbon fiber in the upper layer 3 and the lower layer 2 and the central particle size of the carbon fiber are respectively different will be described below.

(Embodiments)

Table 1 shows the configuration of the resistor in first to ninth embodiments of the invention.

TABLE 1

| | Upper layer | | | | Lower layer | | | | | |
|---|---|---|---|---|---|---|---|---|---|---|
| | | Carbon fiber | | | Percentage | Carbon fiber | | | | |
| | Percentage | | Central | | content of | | Central | | | |
| | content of | Percentage | particle | | carbon | Percentage | particle | | | Maximum |
| | carbon black | content | diameter | Resitivity | black | content | diameter | Resistivity | | abrasion |
| | (volume %) | (volume %) | (μm) | (Ω.cm) | (volume %) | (volume %) | (μm) | (Ω.cm) | Variation | loss (μm) |
| Embodiment | 15 | 18 | 7.2 | 4.67 | 15 | 16 | 1.4 | 5.94 | 0.029 | 0 |
| 1 | | | | | | | | | | |
| Embodiment | 15 | 18 | 7.2 | 4.67 | 15 | 16 | 3.4 | 4.8 | 0.029 | 0 |
| 2 | | | | | | | | | | |
| Embodiment | 15 | 18 | 7.2 | 4.67 | 15 | 16 | 1.4 | 5.94 | 0.03 | 0 |
| 3 | | | | | | | | | | |
| Embodiment | 18 | 18 | 7.2 | 0.03 | 15 | 16 | 1.4 | 5.94 | 0.027 | 0 |
| 4 | | | | | | | | | | |
| Embodiment | 15 | 10 | 8.7 | 1.1 | 15 | 10 | 2 | 1.9 | 0.027 | 0 |
| 5 | | | | | | | | | | |
| Embodiment | 20 | 10 | 8.7 | 0.56 | 10 | 16 | 2 | 4.85 | 0.0305 | 0 |
| 6 | | | | | | | | | | |
| Embodiment | 20 | 20 | 8.7 | 0.37 | 15 | 10 | 2 | 0.9 | 0.028 | 0 |
| 7 | | | | | | | | | | |
| Embodiment | 20 | 20 | 8.7 | 0.37 | 15 | 0 | — | 0.95 | 0.027 | 0 |
| 8 | | | | | | | | | | |
| Embodiment | 20 | 20 | 9 | 0.02 | 15 | 15 | 1.4 | 5.8 | 0.031 | 0 |
| 9 | | | | | | | | | | |
| Comparative | 15 | 0 | — | 1.2 | 15 | 16 | 2 | 1.05 | — | 10 |
| example 1 | | | | | | | | | | |
| Comparative | 15 | 15 | 1.4 | 5.8 | 15 | 15 | 1.4 | 4.5 | — | 8 |
| example 2 | | | | | | | | | | |
| Comparative | 20 | 16 | 2 | 0.3 | 20 | 16 | 2 | 0.3 | — | 3 |
| example 3 | | | | | | | | | | |
| Comparative | 15 | 16 | 3.4 | 2.95 | 10 | 15 | 1.4 | 16 | — | 0.5 |
| example 4 | | | | | | | | | | |
| Comparative | 15 | 16 | 8.7 | 1.78 | 15 | 10 | 2 | 0.9 | 0.042 | 0 |
| example 5 | | | | | | | | | | |
| Comparative | 15 | 16 | 8.7 | 1.78 | 15 | 16 | 2 | 1.47 | 0.0333 | 0 |
| example 6 | | | | | | | | | | |

These resistors are formed as the resistor pattern P in the shape of an arc of which the radius is approximately 7 mm as shown in FIGS. 1 and 2, the thickness of the upper layer 3 is set to approximately 5 μm, the thickness of the lower layer 2 is set to approximately 5 μm and the resistance value of the whole is set to 2.4 kΩ. The silver electrode 4 is connected to both ends of the resistor pattern P.

The slider 5 is made of an alloy including six elements and is revolved on the resistor pattern P. The total angle of rotation of the slider 5 for the resistor pattern P is approximately 120°.

A method of measuring the micro-linearity characteristic will be described below. Suppose that in a state in which the voltage of 5 V is applied from the silver electrode 4 to the resistor pattern P, an ideal straight line of the micro-linearity characteristic has the inclination of 42 mV/deg. from a reference point at which the rotation angle of the slider is 10° and the output of which is 0.5 V. The output is measured every time the slider is revolved by 0.1 deg. and the magnitude of a range in which the output of measurement varies for the ideal straight line is shown as the percentage of the applied voltage 5V. It can be said that the smaller the variation is, the better the micro-linearity characteristic is.

For a method of testing the durability to sliding, after the slider 5 finishes the reciprocation of five million cycles, the worn state of the surface of the resistor is observed and the maximum abrasion loss of the surface of the resistor is measured using a probe-type surface roughness meter.

As clear from Table 1, in first to ninth embodiments in which the central particle size range of the carbon fiber contained in the upper layer 3 is 7.2 to 9.0 μm and the resistivity of the upper layer 3 is smaller than that of the lower layer 2, the micro-linearity characteristic is excellent and the maximum abrasion loss is substantially zero. Further, it is verified that the durability to sliding is also kept even if the ambient temperature of the test of the durability to sliding varies from −40 to 125° C.

In the meantime, the durability to sliding is deteriorated in a comparative example 1 that the upper layer 3 contains no carbon fiber and in comparative examples 1 to 4 that the central particle size range of carbon fiber contained in the upper layer 3 is 1.4 to 3.4 μm, compared with that in the first to ninth embodiments.

In comparative examples 5 and 6 that the resistivity of the upper layer 3 is larger than that of the lower layer 2, the micro-linearity characteristic is deteriorated, compared with that in the first to ninth embodiments.

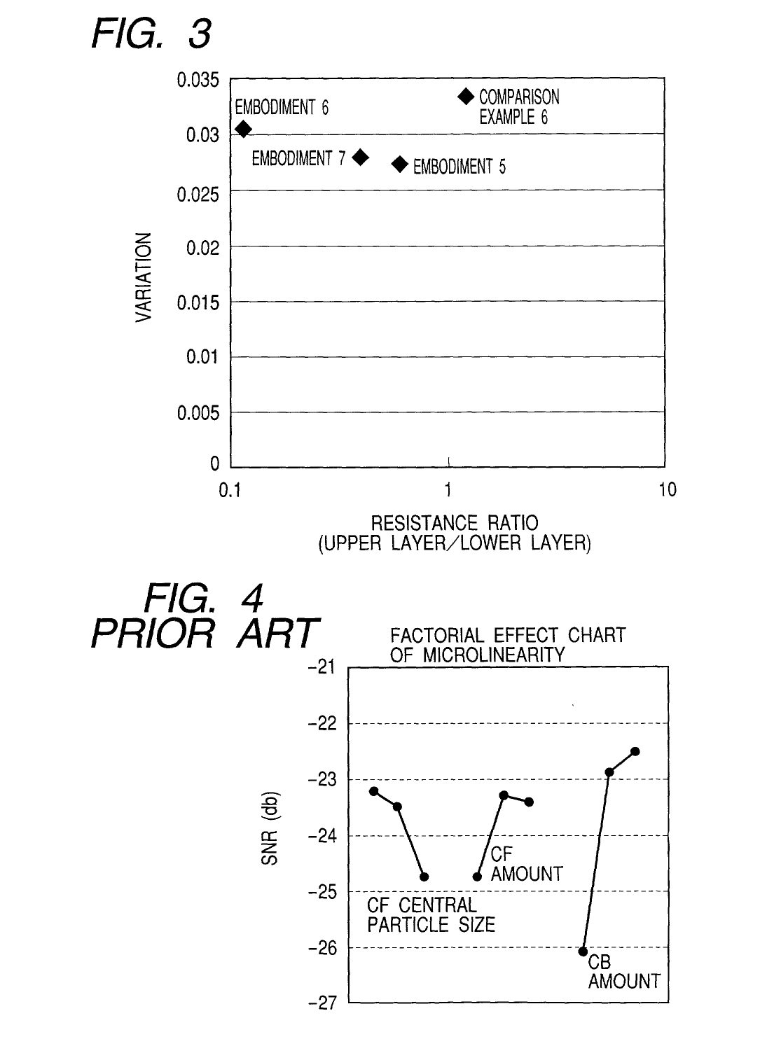

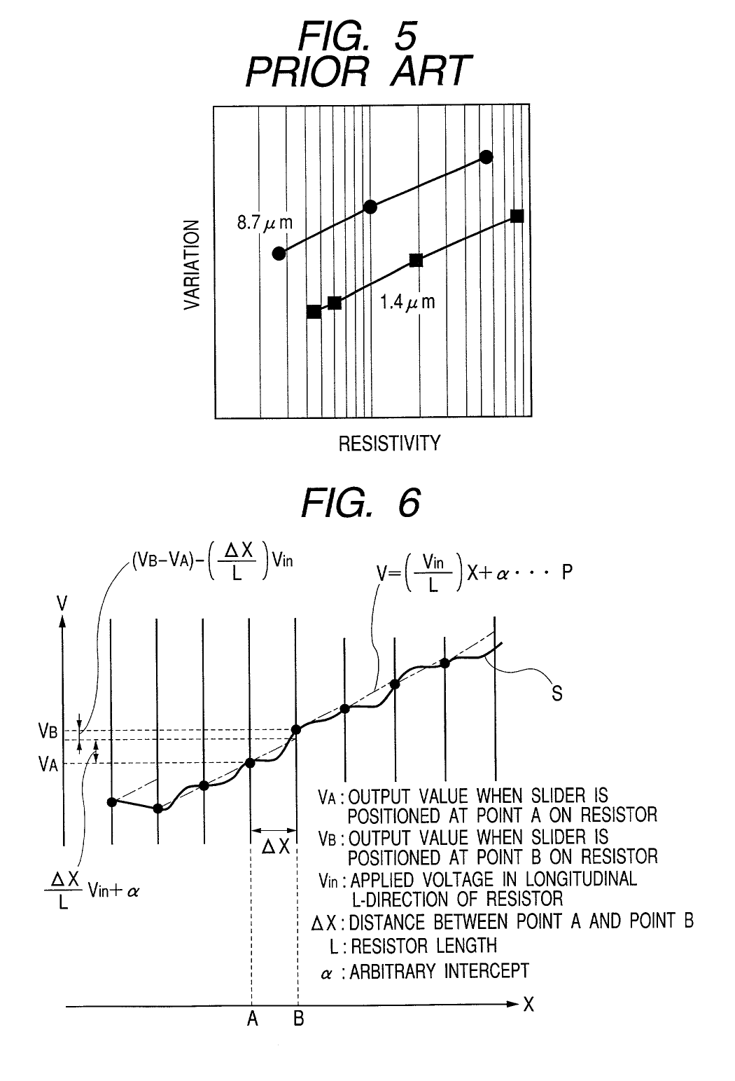

FIG. 3 is a graph showing an influence of the resistivity of the upper layer 3 to that of the lower layer 2 upon the micro-linearity characteristic in the sixth, seventh and fifth embodiments and the comparative example 6 shown in Table 1. As clear from this graph, when the ratio of the resistance (the upper layer/the lower layer) decreases from that in the comparative example 6 to that in the fifth embodiment, the micro-linearity characteristic is enhanced, however, when the ratio of the resistance (the upper layer/the lower layer) further decreases from that in the seventh embodiment to that in the sixth embodiment, the micro-linearity characteristic is slightly deteriorated.

This is because, when the resistivity of the upper layer 3 to that of the lower layer 2 becomes small, the micro-linearity characteristic is enhanced, while the anisotropy in conduction of the carbon fiber contained in the upper layer 3 has an influence upon the micro-linearity characteristic. Therefore, it is desirable that the ratio of the resistivity of the upper layer 3 to that of the lower layer 2 is 0.1 or more.

The first and second resistors forming the resistor according to the invention contain conductive particles in binder resin, the second resistor contains carbon fiber and carbon black, the central particle size range of the carbon fiber contained in the second resistor is 3.5 to 9.0 μm, the resistivity of the second resistor is smaller than the resistivity of the first resistor, at least the first and second resistors are laminated, the second resistor covers the upside of the first resistor and the surface is formed by the second resistor.

As such a resistor is provided with at least the first and second resistors, the resistor can have a desired value by reducing the resistivity of the second resistor on which the slider is slid, enhancing the micro-linearity characteristic of the resistor and regulating the resistance value of the whole resistor by the first resistor of which the resistivity is large.

The carbon fiber contained in the second resistor is conductive particles, applies conductivity to the second resistor and can disperse and support a load applied from the slider to the resistor in the direction of fiber length. Therefore, the durability of the resistor to the load of the slider is enhanced and the characteristic is also kept even if the ambient temperature varies. Electric contact between the resistor and the slider is stabilized because the carbon fiber which is conductive particles supports the load of the slider.

What is claimed is:

1. A resistor,
wherein first and second resistors contain conductive particles in binder resin
wherein the second resistor contains carbon fiber and carbon black,
wherein a central particle size range of the carbon fiber contained in the second resistor is 3.5 to 9.0 μm,
wherein the resistivity of the second resistor is smaller than that of the first resistor,
wherein at least the first and second resistors are laminated,
wherein the second resistor covers an upside of the first resistor, and
wherein a surface is formed of the second resistor.

2. A resistor according to claim 1, wherein the first resistor contains carbon fiber and carbon black.

3. A resistor according to claim 2, wherein a central particle size of the carbon fiber contained in the first resistor is equal to or smaller than that of the carbon fiber contained in the second resistor.

4. A resistor according to claim 1, wherein the second resistor contains carbon fiber by 16 to 20% by volume.

5. A resistor according to claim 1, wherein a ratio of the resistivity of the second resistor to the resistivity of the first resistor is equal to or larger than 0.1 and is smaller than 1.

6. A resistor according to claim 1,
wherein a surface of the second resistor is smoothed, and
wherein the maximum surface roughness is 0.5 μm or less.

7. A variable resistor,
wherein the resistor according to claim 1 is used, and
wherein a slider made of metal is slid on the surface of the second resistor.

8. A variable resistor according to claim 7, wherein the first resistor in the resistor contains carbon fiber and carbon black.

9. A variable resistor according to claim 8, wherein the central particle size of the carbon fiber contained in the first resistor in the resistor is equal to or smaller than that of the carbon fiber contained in the second resistor.

10. A variable resistor according to claim 7, wherein the second resistor in the resistor contains carbon fiber by 16 to 20% by volume.

11. A variable resistor according to claim 7, wherein the ratio of the resistivity of the second resistor in the resistor to the resistivity of the first resistor is equal to or larger than 0.1 and is smaller than 1.

12. A variable resistor according to claim 7,
wherein the surface of the second resistor in the resistor is smoothed, and
wherein the maximum surface roughness is 0.5 μm or less.
